(19) United States
(12) Patent Application Publication
(10) Pub. No.: US 2004/0019887 A1
(43) Pub. Date: Jan. 29, 2004

(54) Method, system, and program for loading program components

(75) Inventors: Brandon E. Taylor, Longmont, CO (US); William H. Connor, Boulder, CO (US)

Correspondence Address: David W. Victor, KONRAD RAYNES VICTOR & MANN LLP, Suite 210, 315 S. Beverly Drive, Beverly Hills, CA, 90212, US

(73) Assignee: Sun Microsystems, Inc.

(21) Appl. No.: 10/205,753

(22) Filed: Jul. 25, 2002

(51) Int. Cl. G06F 9/44; G06F 9/45

(52) U.S. Cl. 717/166; 717/118; 717/148

(57) ABSTRACT

Provided are a method, system, and program for loading program components into a runtime environment. A loader hierarchy is provided indicating an order in which loaders are invoked to load multiple types of program components. A plurality of first type loaders are used to load a first type of program components that are capable of being used by a second type of program components loaded by at least one second type loader. The second type loader is defined at a lower level in the loader hierarchy than the first type component loaders.

### BACKGROUND OF THE INVENTION

1. Field of the Invention

The present invention relates to a method, system, and program for loading program components.

2. Description of the Related Art

In the Java** runtime environment, which is implemented by a Java Virtual Machine, software components may be dynamically loaded by one or more dynamic class loaders. In Java, a class of software components is represented by one or more class files executed by the JVM. A class loader method takes a class name as an argument when called and returns a class object that is a runtime representation of a class type. Certain class loaders may be used to load facilities and components that are intended to be shared among different classes and certain other class loaders may be used to load application specific or other user-defined classes that are not shared. **Sun Microsystems and Java are trademarks of Sun Microsystems, Inc.

A hierarchical relationship is defined among multiple class loaders indicating how the class loaders delegate class loading to class loaders at a higher level in the hierarchy, i.e., ancestor class loaders. Each class loader other than the primordial class loader (which is that class loader that starts the class loading process) has exactly one parent class loader. When called to load a class, the called class loader would delegate the class loading to any class loaders defined as parents in the hierarchy. The highest level ancestor class loader in the hierarchy that is capable of loading the desired class would load the class on behalf of the called class loader. If there is no higher level ancestor class loader, as defined in the class loader hierarchy, capable of loading the requested class, then the original initiating class loader would load the class. In certain situations, no class loader may be available to load a class, which would result in an exception being thrown. Those classes loaded by an ancestor class loader are shared by the classes loaded by class loaders lower in the class loader hierarchy, i.e., class loaders that are descendants of the ancestor class loader delegated to load the classes. Further details of class loading are described in the publication “Dynamic Class Loading in the Java™ Virtual Machine”, by S. Liang and G. Bracha (Association of Computing Machinery, 1998), which publication is incorporated herein by reference in its entirety.

For instance, if a web browser application, such as a Java applet, attempts to load a class, the system class loader will ultimately be delegated to load the class if the class is a Java core class. The applet class loader will load the class if the class is specific to that applet. In this way, classes from different applets cannot access each other because they are not loaded by a parent class loader at a higher hierarchical level in the delegation model.

There are certain disadvantages with current class loading techniques. In the prior art, to share common classes among separate components, a single class loader is sometimes used to load all shared classes so that all shared classes are available to child or lower level component class loaders in the classloader hierarchy. However, this technique has many disadvantages. For instance, in the prior art, for those classes loaded by the common ancestor class loader, a single annotation is used, so that all shared classes loaded by the the class loader share that annotation. When a client requests a class loaded by the common class loader, such as a client requesting an exportable class, the annotation including information on all the classes loaded by the root class loader would be accessed and searched, which would potentially involve the access of information on numerous classes that are not of interest to the client. For instance, a client interested in exportable classes would receive information in the annotation that is not relevant to the requesting client, such as information on unneeded exportable classes. Further, shared classes loaded by the common class loader share the same security policy, even though it may be preferable to have different security and access levels for different shared classes. An exportable resource is a resource that may be network loaded when a client uses a component associated with the exportable class. A domestic resource is a resource associated with a component that should never be loaded over the network into a client address space.

For these reasons, there is a need in the art for improved techniques for loading software components into a runtime environment.

### SUMMARY OF THE EMBODIMENTS

Provided are a method, system, and program for loading program components into a runtime environment. A loader hierarchy is provided indicating an order in which loaders are invoked to load multiple types of program components. A plurality of first type loaders are used to load a first type of program components that are capable of being used by a second type of program components loaded by at least one second type loader. The second type loader is defined at a lower level in the loader hierarchy than the first type component loaders.

In further implementations, the first type of program components comprise shared program components, the second type of program components comprise non-shared program components, the first type loaders comprise shared component loaders, and the second type loader comprises a non-shared component loader. Non-shared program components loaded by non-shared component loaders are not capable of being used by non-shared program components loaded by other non-shared component loaders.

In still further implementations, the loader hierarchy is used to determine one first type or second type component loader to use to load one second type program component capable of being loaded by one second type loader.

Still further, using the loader hierarchy to load the second type program component capable of being loaded by one second type loader may further include determining a highest first type loader according to the loader hierarchy capable of loading the second type program component and using the determined highest first type loader to load the second type program component if one first type component loader is capable of loading the second type program component.

Yet further, the second type program loader capable of loading the second type program component may be used to load the second type program component if no first type component loader is capable of loading the second type program component.

Described implementations provide techniques for loading different types of program components to allow the certain types of program components, such as shared program components, to be loaded by multiple component loaders.

### BRIEF DESCRIPTION OF THE DRAWINGS

Referring now to the drawings in which like reference numbers represent corresponding parts throughout:

FIG. 1 illustrates a computing environment in accordance with certain implementations of the invention;

FIG. 2 illustrates a class loader hierarchy in accordance with certain implementations of the invention;

FIG. 3 illustrates logic to load classes according to the class loader hierarchy; and

FIG. 4 illustrates a computer architecture in which aspects of the invention may be implemented.

### DETAILED DESCRIPTION OF THE PREFERRED EMBODIMENTS

In the following description, reference is made to the accompanying drawings which form a part hereof and which illustrate several embodiments of the present invention. It is understood that other embodiments may be utilized and structural and operational changes may be made without departing from the scope of the present invention.

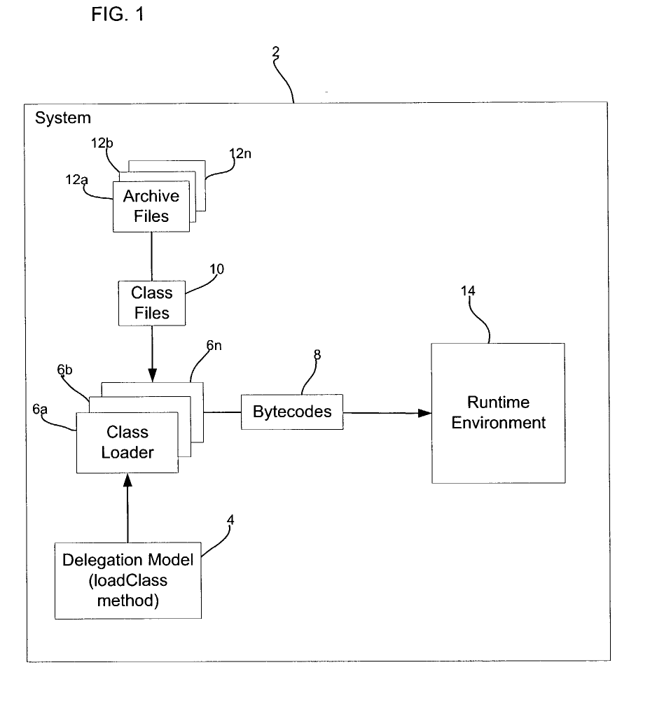

FIG. 1 illustrates a computing environment in which aspects of the invention are implemented. A system 2 includes a class loader hierarchy 4 indicating the relative ordering with which class loaders 6a, 6b . . . 6n in the hierarchy are provided an opportunity to load bytecodes 8 from class files 10, which may be maintained in archive files 12a, 12b . . . 12n, into a runtime environment 14, such as the Java** runtime environment. In certain implementations, the archive files 12a, 12b . . . 12n may comprise Java Archive Files (JAR) or Component Archive Files (CAR) described in the commonly assigned and copending patent applications entitled “Method, System, and Program for Making Objects Available for Access to a Client over a Network”, by William H. Connor and Brandon E. Taylor, having attorney docket number P7294, and “Method, System, and Program for Processing Objects in a Distributed Computing Environment”, by William H. Connor and Brandon E. Taylor, having attorney docket number P7293, which patent applications are incorporated herein by reference in their entirety. In implementations where one or more archive files 12a, 12b . . . 12n are CAR files, such CAR files may include multiple indexable JAR files, each including a different set of classfiles. The indexable JAR files may comprise exportable classes needed by client systems in a Remote Method Invocation (RMI) environment to process objects received from a server. However, in certain implementations only domestic classes and not exportable classes are loaded according to the class hierarchy.

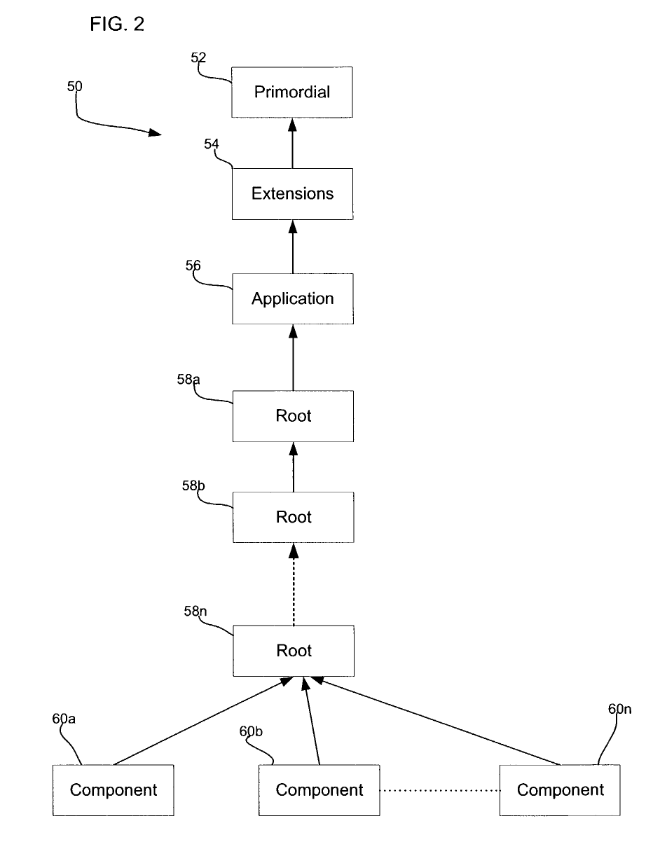

FIG. 2 illustrates a class loader hierarchy 50 indicating the order in which class loaders will be considered for loading a class in the delegation model 4. In the class loader hierarchy 50, the lower level class loader that is called to load a class will attempt to have the highest level class loader capable of loading the requested class load such class. In the hierarchy 50, the primordial class loader 52 is the class loader having no parent class loader and is used to load all Java core classes to bootstrap the runtime environment 14, such as Java Development Kit (JDK) internal classes, java.* packages included in the JVM (e.g., java.lang.String.); the extension class loader 54 may load the class files 10 in archive files 12a, 12b . . . 12n placed in the extensions directory of the JDK; the application class loader 56 loads classes used to implement an application program, whose components are used by different programs written for such application program, e.g., applets, that are intended to execute in the application.

For instance, a Java application can instantiate multiple user-defined class loaders either from the same class or from multiple classes, and may create as many (and as many different kinds of) user-defined class loaders as it needs; a plurality of root class loaders 58a . . . . 58n that load shared classes and common interfaces, such as those that allow communication between components in the system, facility interfaces, or any other components that are shared by different component classes that implement specific user programs; and component class loaders 60a, 60b . . . 60n that load the variable components of the system, such as services, facility implementations, plug-ins, and dynamically loaded modules.

In certain implementations, the components loaded by the root class loaders 54a, 54b . . . 54n comprise fixed components. Further, during operations in the runtime environment 14, particularly during RMI remote calls, other class loaders may be created below the component class loaders 60a, 60b . . . 60n. For example, if a service loaded by a component class loader L were to download a proxy to another service from the service registrar, RMI would usually create a lower class loader, with L as its parent, to load the proxy class.

In the described implementations, the common interfaces that include classes shared by the different component classes are loaded by one of multiple root class loaders 58a, 58b . . . 58n, thereby dividing the shared classes among multiple class loaders. For instance, if there were several facilities to use, then a separate root class loader 58a, 58b . . . 58n would be used to load each facility, as opposed to having a single class loader load all facilities and shared components. With the class loader hierarchy 50, all the separate components loaded by component class loaders 60a, 60b . . . 60n can share the facility and common classes loaded by the root class loaders 58a, 58b . . . 58n because they are at a lower level in the delegation hierarchy, i.e., the class loader method implementing the delegation model 4 will attempt to delegate the loading of a component to the root class loaders 58a, 58b . . . 58n when any of the component class loaders 60a, 60b . . . 60n are called to load a component class.

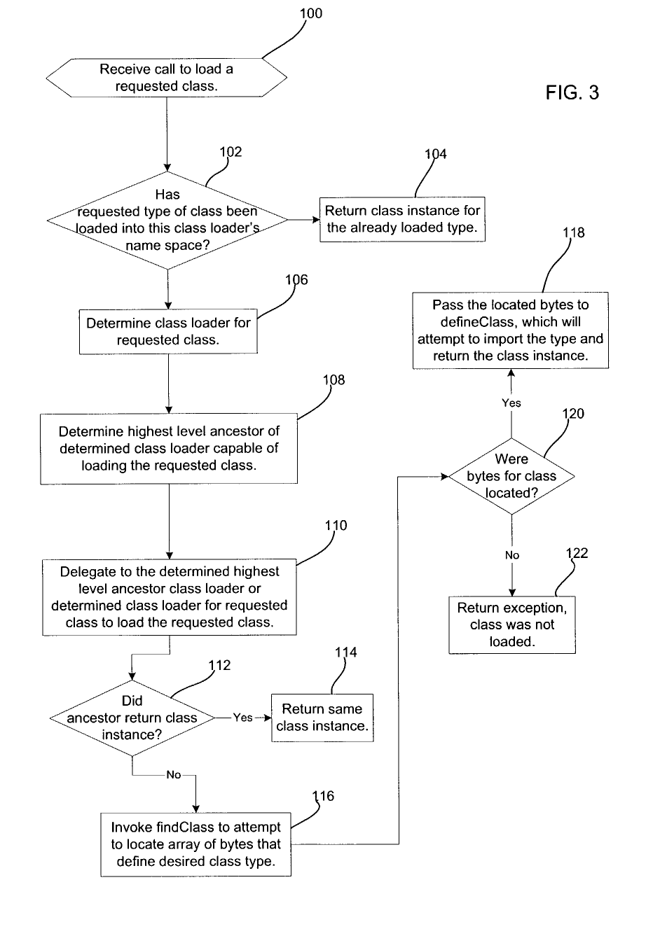

FIG. 3 illustrates logic implemented in the ClassLoader.loadClass( ) method 4 implementing the delegation model having the class loader hierarchy 50 shown in FIG. 2 to load classfiles. Control begins at block 100 upon receiving a call to load a requested class. In response, the loadClass method implementing the delegation model 4 is invoked and determines (at block 102) whether the requested type of class is already loaded in the runtime environment 14. If so, then a reference to the loaded requested class type is returned (at block 104) to use. Otherwise, the loadClass( ) method determines (at block 106) the class loader for the requested class by determining (at block 108) the highest level ancestor of the initiating class loader capable of loading the requested class. If the initiating class loader for the requested class is a component class loader, then any one of the highest level root class loader 58a, 58b . . . 48n or any other higher level class loader (e.g., application 56, extensions 54, or primordial 52) capable of loading the requested class is called (at block 110) to load the requested class.

If (at block 112) the ancestor class loader returns the class instance, then that same class instance is returned (at block 114). Otherwise, a call is made (at block 116) to the findClass method to attempt to locate an array of bytes that define the desired class type. If (at block 120) the bytes for the class were located, then the located bytes are passed (at block 118) to the defineClass, which attempts to import the byte codes of the requested class type and return the class instance. Otherwise, if (at block 120) the bytes for the requested class were not located, then an exception is returned (at block 122).

With the described class loader hierarchy, the shared components and facilities including interfaces and objects that may be utilized by the component classes loaded by component class loaders 60a, 60b . . . 60n are loaded by separate root class loaders 58a, 58b . . . 58n. In certain implementations, as shown in FIG. 2, the root class loaders 58a, 58b . . . 58n are arranged in a hierarchical order such that root class loaders at a relatively higher level, e.g., root class loader 58a, capable of loading a component class are used before root class loaders at a relatively lower level in the hierarchy, e.g., root class loaders 58b . . . 58n. The delegation logic 4 indicating the class loader hierarchy may be coded in the ClassLoader.loadClass( ) method or other method using interfaces manner known in the art.

With the described implementations of using multiple root class loaders, annotations providing information on shared classes loaded by multiple root class loaders are smaller and more specific than the annotations provided with a single root class loader to load all the shared classes because there are fewer shared classes referred to by the annotations per root class loader. Smaller annotations are easier to search and load, especially when many of the shared classes may not be loaded into the runtime environment 14 and their annotations not needed. Moreover, with the described multiple root class loader implementations, separate security policies can be used for each root class loader 58a, 58b . . . 58n, thereby allowing different security levels for shared classes loaded by different root class loaders 58a, 58b . . . 58n. With the prior art single class loader technique, all shared classes loaded by the single class loader are restricted to having the same security policy.

Still further, in certain implementations that utilize multiple component class loaders, classes loaded by the component class loaders 60a, 60b . . . 60n are likely to be released from the memory or runtime environment 14 during garbage collection because the fewer the number of classes loaded by a class loader, the more likely all the loaded classes for a class loader are eligible for garbage collection. Further, by using multiple component class loaders 60a, 60b . . . 60n, different versions of a class loaded by component class loaders can be loaded simultaneously, where each version may be loaded by a different class loader.

### Additional Implementation Details

The above described method, apparatus or article of manufacture for loading software components may use standard programming and/or engineering techniques to produce software, firmware, hardware, or any combination thereof. The term “article of manufacture” as used herein refers to code or logic implemented in hardware logic (e.g., an integrated circuit chip, Programmable Gate Array (PGA), Application Specific Integrated Circuit (ASIC), etc.) or a computer readable medium (e.g., magnetic storage medium (e.g., hard disk drives, floppy disks, tape, etc.), optical storage (CD-ROMs, optical disks, etc.), volatile and non-volatile memory devices (e.g., EEPROMs, ROMs, PROMs, RAMs, DRAMs, SRAMs, firmware, programmable logic, etc.). Code in the computer readable medium is accessed and executed by a processor. The code in which preferred embodiments of the configuration discovery tool are implemented may further be accessible through a transmission media or from a file server over a network. In such cases, the article of manufacture in which the code is implemented may comprise a transmission media, such as a network transmission line, wireless transmission media, signals propagating through space, radio waves, infrared signals, etc. Of course, those skilled in the art will recognize that many modifications may be made to this configuration without departing from the scope of the present invention, and that the article of manufacture may comprise any information bearing medium known in the art.

The described implementations utilized an archive file. In alternative implementations, the archive file of the described implementations may conform to specifications other than the JAR file specification. Further, the classfiles can be provided from data structures other than CAR and JAR archive files.

The described implementations utilized the Java programming language and the Java RMI communication protocol. Alternatively, the implementations may utilize other object oriented programming languages, such as C++, Smalltalk, etc. Further, the interface between the client and server may utilize alternative communication protocols to handle the remote calls, such as SOAP, Common Object Request Broker Architecture (CORBA), Remote Procedure Call (RPC), Distributed Relational Database Architecture (DRDA), etc. In implementations using alternative communication protocols for the remote communications, the client and server would implement the communication specific related methods.

In certain described implementations, the loader technique is used to load classes from Java classfiles. In alternative implementations, the loader technique described herein may be used to load any type of file or object available for download, not just archive files or classfiles, and for programming environments other than Java.

In the described implementations, the class loaders at the bottom of the hierarchy load variable type components and certain class loaders at the relatively higher level comprise root class loaders to load shared classes. In additional implementations, the class loaders at the higher and lower levels may load components other than shared components and variable components.

FIG. 2 illustrates multiple component loaders. In alternative implementations, only a single component loader loading non-shared classes may be used.

FIG. 3 illustrates specific operations occurring in a particular order. In alternative implementations, certain of the logic operations may be performed in a different order, modified or removed and still implement preferred embodiments of the present invention. Moreover, steps may be added to the above described logic and still conform to the preferred embodiments. Further, operations described herein may occur sequentially or certain operations may be processed in parallel. Yet further, operations described herein may be performed by a single process and/or processing unit or distributed among a plurality of processes and/or processing units.

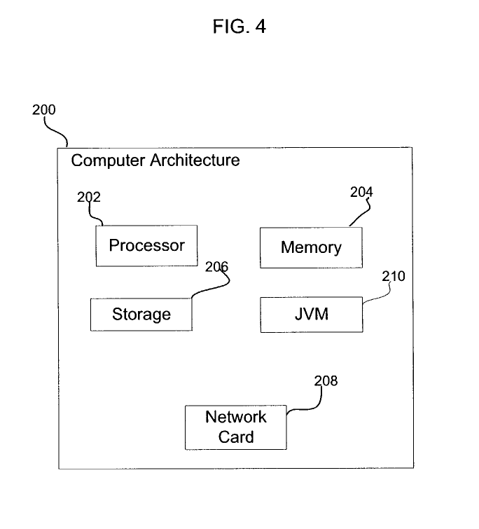

FIG. 4 illustrates one implementation of the system architecture of the client 2 (FIG. 1). The system 2 may implement a computer architecture 200 having a processor 202 (e.g., a microprocessor), a memory 204 (e.g., a volatile memory device), and storage 206 (e.g., a non-volatile storage, such as magnetic disk drives, optical disk drives, a tape drive, etc.). The storage 206 may comprise an internal storage device or an attached or network accessible storage. Programs in the storage 206 are loaded into the memory 204 and executed by the processor 202 in a manner known in the art. The architecture further includes a network card 208 to enable communication with a network. Further, in certain implementations, the architecture may include a virtual machine program, such as the Java Virtual Machine (JVM) 210. In alternative implementations, the client 2 and server 4 may comprise processes in separate addresses spaces in a single computer system, such as a system having the architecture shown in FIG. 4.

The foregoing description of various implementations of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for loading program components into a runtime environment, comprising:
providing a loader hierarchy indicating an order in which loaders are invoked to load multiple types of program components; and
using a plurality of first type loaders to load a first type of program components that are capable of being used by a second type of program components loaded by at least one second type loader, wherein each second type loader is defined at a lower level in the loader hierarchy than the first type component loaders.

2. The method of claim 1, wherein the first type of program components comprise shared program components, the second type of program components comprise non-shared program components, the first type loaders comprise shared component loaders, the at least one second type loader comprises a non-shared component loader, and wherein non-shared program components loaded by one non-shared component loader is not capable of being used by non-shared program components loaded by other non-shared component loaders.

3. The method of claim 2, wherein the shared program components comprise common interfaces enabling communication between components in the system.

4. The method of claim 2, wherein the non-shared program components loaded by the at least one non-shared component loader comprises variable system components that are a member of a set of non-shared program components comprising: services, facility implementations, plug-ins, and dynamically loaded modules.

5. The method of claim 2, further comprising:
using multiple non-shared component loaders to load sets of non-shared program components;
determining whether one set of non-shared program components loaded by one non-shared component loader are available to be removed from the runtime environment; and
indicating the determined set of non-shared program components as available for removal from the runtime environment.

6. The method of claim 2, further comprising:
providing annotations for each shared component loader to provide information on the shared program components loaded by the shared component loader, wherein the annotations for one shared program component loader do not include annotations for shared program components loaded by other shared component loaders.

7. The method of claim 2, wherein different security policies are associated with different shared component loaders, thereby providing different security policies for shared program components loaded by different shared component class loaders.

8. The method of claim 1, wherein the first and second types of program components to load include class files including interfaces and wherein the first type and second type loaders load interfaces of the class files into the runtime environment.

9. The method of claim 8, wherein the first type and second type loaders comprise Java class loaders.

10. The method of claim 9, wherein the first type of loaders comprise root class loaders and wherein the second type of loaders comprise component class loaders.

11. The method of claim 1, further comprising:
using the loader hierarchy to determine one first type or second type component loader to use to load one second type program component capable of being loaded by one second type loader.

12. The method of claim 11, wherein using the loader hierarchy to load the second type program component capable of being loaded by one second type loader comprises:
determining a highest first type loader according to the loader hierarchy capable of loading the second type program component; and
using the determined highest first type loader to load the second type program component if one first type component loader is capable of loading the second type program component.

13. The method of claim 12, further comprising:
using the second type program loader capable of loading the second type program component if no first type component loader is capable of loading the second type program component.

14. A system for loading program components into a runtime environment, comprising:
means for providing a loader hierarchy indicating an order in which loaders are invoked to load multiple types of program components; and
means for using a plurality of first type loaders to load a first type of program components that are capable of being used by a second type of program components loaded by at least one second type loader, wherein each second type loader is defined at a lower level in the loader hierarchy than the first type component loaders.

15. The system of claim 14, wherein the first type of program components comprise shared program components, the second type of program components comprise non-shared program components, the first type loaders comprise shared component loaders, the at least one second type loader comprises a non-shared component loader, and wherein non-shared program components loaded by one non-shared component loader is not capable of being used by non-shared program components loaded by other non-shared component loaders.

16. The system of claim 15, wherein the shared program components comprise common interfaces enabling communication between components in the system.

17. The system of claim 16, wherein the non-shared program components loaded by the at least one non-shared component loader comprises variable system components that are a member of a set of non-shared program components comprising: services, facility implementations, plug-ins, and dynamically loaded modules.

18. The system of claim 15, further comprising:
means for using multiple non-shared component loaders to load sets of non-shared program components;
means for determining whether one set of non-shared program components loaded by one non-shared component loader are available to be removed from the runtime environment; and
means for indicating the determined set of non-shared program components as available for removal from the runtime environment.

19. The system of claim 15, further comprising:
means for providing annotations for each shared component loader to provide information on the shared program components loaded by the shared component loader,
wherein the annotations for one shared program component loader do not include annotations for shared program components loaded by other shared component loaders.

20. The system of claim 15, wherein different security policies are associated with different shared component loaders, thereby providing different security policies for shared program components loaded by different shared component class loaders.

21. The system of claim 14, wherein the first and second types of program components to load include class files including interfaces and wherein the first type and second type loaders load interfaces of the class files into the runtime environment.

22. The system of claim 21, wherein the first type and second type loaders comprise Java class loaders.

23. The system of claim 22, wherein the first type of loaders comprise root class loaders and wherein the second type of loaders comprise component class loaders.

24. The system of claim 14, further comprising:
means for using the loader hierarchy to determine one first type or second type component loader to use to load one second type program component capable of being loaded by one second type loader.

25. The system of claim 24, wherein the means for using the loader hierarchy to load the second type program component capable of being loaded by one second type loader further performs:
determining a highest first type loader according to the loader hierarchy capable of loading the second type program component; and
using the determined highest first type loader to load the second type program component if one first type component loader is capable of loading the second type program component.

26. The system of claim 25, further comprising:
means for using the second type program loader capable of loading the second type program component if no first type component loader is capable of loading the second type program component.

27. An article of manufacture for loading program components into a runtime environment, wherein the article of manufacture causes operations to be performed, the operations comprising:
providing a loader hierarchy indicating an order in which loaders are invoked to load multiple types of program components; and
using a plurality of first type loaders to load a first type of program components that are capable of being used by a second type of program components loaded by at least one second type loader, wherein each second type loader is defined at a lower level in the loader hierarchy than the first type component loaders.

28. The article of manufacture of claim 27, wherein the first type of program components comprise shared program components, the second type of program components comprise non-shared program components, the first type loaders comprise shared component loaders, the at least one second type loader comprises a non-shared component loader, and wherein non-shared program components loaded by one non-shared component loader is not capable of being used by non-shared program components loaded by other non-shared component loaders.

29. The article of manufacture of claim 28, wherein the shared program components comprise common interfaces enabling communication between components in the system.

30. The article of manufacture of claim 28, wherein the non-shared program components loaded by the at least one non-shared component loader comprises variable system components that are a member of a set of non-shared program components comprising: services, facility implementations, plug-ins, and dynamically loaded modules.

31. The article of manufacture of claim 28, further comprising:
using multiple non-shared component loaders to load sets of non-shared program components;
determining whether one set of non-shared program components loaded by one non-shared component loader are available to be removed from the runtime environment; and
indicating the determined set of non-shared program components as available for removal from the runtime environment.

32. The article of manufacture of claim 28, further comprising:
providing annotations for each shared component loader to provide information on the shared program components loaded by the shared component loader, wherein the annotations for one shared program component loader do not include annotations for shared program components loaded by other shared component loaders.

33. The article of manufacture of claim 28, wherein different security policies are associated with different shared component loaders, thereby providing different security policies for shared program components loaded by different shared component class loaders.

34. The article of manufacture of claim 27, wherein the first and second types of program components to load include class files including interfaces and wherein the first type and second type loaders load interfaces of the class files into the runtime environment.

35. The article of manufacture of claim 34, wherein the first type and second type loaders comprise Java class loaders.

36. The article of manufacture of claim 35, wherein the first type of loaders comprise root class loaders and wherein the second type of loaders comprise component class loaders.

37. The article of manufacture of claim 27, further comprising:
using the loader hierarchy to determine one first type or second type component loader to use to load one second type program component capable of being loaded by one second type loader.

38. The article of manufacture of claim 37, wherein using the loader hierarchy to load the second type program component capable of being loaded by one second type loader comprises:
determining a highest first type loader according to the loader hierarchy capable of loading the second type program component; and
using the determined highest first type loader to load the second type program component if one first type component loader is capable of loading the second type program component.

39. The article of manufacture of claim 38, further comprising:
using the second type program loader capable of loading the second type program component if no first type component loader is capable of loading the second type program component.

40. A memory device including at least one data structure, comprising:
a loader hierarchy indicating an order in which loaders are invoked to load multiple types of program components, wherein a plurality of first type loaders are used to load a first type of program components that are capable of being used by a second type of program components loaded by at least one second type loader, wherein each second type loader is defined at a lower level in the loader hierarchy than the first type component loaders.

41. The memory device of claim 40, wherein the first type of program components comprise shared program components, the second type of program components comprise non-shared program components, the first type loaders comprise shared component loaders, the at least one second type loader comprises a non-shared component loader, and wherein non-shared program components loaded by one non-shared component loader is not capable of being used by non-shared program components loaded by other non-shared component loaders.

42. The memory device of claim 41, wherein multiple non-shared component loaders are used to load sets of non-shared program components.

43. The memory device of claim 41, further comprising:
annotations for each shared component loader to provide information on the shared program components loaded by the shared component loader, wherein the annotations for one shared program component loader do not include annotations for shared program components loaded by other shared component loaders.

44. The memory device of claim 41, wherein different security policies are associated with different shared component loaders, thereby providing different security policies for shared program components loaded by different shared component class loaders.

45. The memory device of claim 40, wherein the first and second types of program components to load include class files including interfaces and wherein the first type and second type loaders load interfaces of the class files into the runtime environment.

46. The memory device of claim 40, wherein the loader hierarchy is used to determine one first type or second type component loader to use to load one second type program component capable of being loaded by one second type loader.
